(19) United States
(12) Patent Application Publication
(10) Pub. No.: US 2004/0166037 A1
(43) Pub. Date: Aug. 26, 2004

(54) Air filtration and treatment apparatus

(76) Inventors: Harry F. Youdell, Miami, FL (US); John B. McIntyre, Duluth, GA (US); Scott C. Nagy, Snellville, GA (US)

Correspondence Address: NEEDLE & ROSENBERG, P.C., SUITE 1000, 999 PEACHTREE STREET, ATLANTA, GA, 30309-3915, US

(21) Appl. No.: 10/374,961

(22) Filed: Feb. 25, 2003

(51) Int. Cl. B01J 19/08

(52) U.S. Cl. 422/186.3

(57) ABSTRACT

An air filtration system for use in filtering a pressurized air flow, the system comprising a primary particulate filter for removal of at least a portion of particulate matter entrained in the air flow, at least one ultraviolet lamp, and a permeable reaction filter. The ultraviolet lamp is positioned downstream of the primary particulate filter and the permeable reaction filter is positioned downstream of the ultraviolet light. The permeable reaction filter has a substrate member and a plurality of titanium dioxide particles bonded to portions of the substrate member to form a photo-catalytic oxidizer layer disposed thereon a portion of the substrate member. The ultraviolet lamp irradiates at least a portion of the permeable reaction layer so that at least a portion of contaminants entrained in the air flow. The system may also include an adsorption filter positioned downstream of the permeable reaction filter.

### FIELD OF THE INVENTION

This invention relates generally to air cleansing apparatus. More particularly for air cleansing apparatus for use within structures as a stand alone unit or integrated within ventilation systems, and still more particularly to ultraviolet irradiation and filtration apparatus for use with conventional ventilation systems such as those found in residential and commercial properties.

### THE PRIOR ART

The typical residential and commercial property has a conventional heating and air conditioning ventilation (HVAC) system uses a primary conventional particle filter to prevent airborne debris from entering the ventilation system. Such a primary particle filter generally can stop large particles such as, for example, leaves, large dirt particles, hair, lint, cloth fibers, etc., from interfering with the operation of the system. Particles as large as dust are generally not inhibited from passage into the system by such a conventional particle filter. For removal of finer particles, some HVAC systems use or include a high efficiency particle arresting (HEPA) filter. These HEPA filters are typically approximately 73% efficient at trapping particles larger than 0.3 micron and are typically approximately 95% efficient at trapping particles larger than 1.0 micron. Such filters cannot be too efficient however because a too efficient filter can block the passage of air and may create a back pressure that causes the HVAC system air blower to struggle to move air through the system.

With regard to HVAC systems, biological contaminants, such as, for example, bacteria and viruses, are difficult to control because the moist environment is conducive to contaminant growth. The most common strategy employed in conventional HVAC systems is to include a HEPA filter to rid the indoor air of biological contaminants. Unfortunately, such filters are typically inadequate because many of the organisms forming the biological contaminants can pass right through the filter. For example, most viruses range in size from approximately 0.003 to 0.06 microns and are readily past through a conventional filter for distribution throughout the ventilation system. Further, most bacteria range in size from between 0.4 to 0.5 microns and can either pass through the filter into the ventilation system or become trapped within the filter. Any organisms that collect on the filter can form germ colonies that may soon be sloughed off into passing air and thence into the ventilation system. Also, the materials that gather on the filter may act as a food source and may produce volatile and non-volatile organic compounds as well as molds and mold byproducts, such as, for example, mycotoxins, that are release into the air flowing downstream of the particulate filter.

Thus, in many situations, the conventional filters, even a HEPA filter, act as an organism amplifier. In many instances, even if the filters are changed regularly, it is not uncommon to find filters filled with biological contaminants and the associated closed ventilation systems may lead to what has been called “sick buildings.” Modern construction techniques restrict air leakage from the exterior envelope of the building to reduce energy losses. The air restriction can also trap moisture in the building and may trap chemical vapors such as formaldehyde, carbon monoxide, ammonia, and the like. The occupants of sick buildings, whether they be residential or commercial buildings, have symptomatic complaints for a variety of physiological and neurological disorders which do not fit the pattern or symptom of any particular illness and are difficult to trace to any specific source.

In an effort to overcome the limitations of using just a particulate filter in a HVAC system, it is known to use an ultraviolet (UV) light that is placed in-line in a duct of the system downstream of the particulate filter. The ultraviolet light serves to destroy many biological contaminants that pass through the primary particulate filters. Further, it is known to provide an activated carbon filter in the system either before or after the UV light for reducing undesirable vapors that may be present in the air passing through the system. However, the prior art systems generally fail to effectively remove the typical contaminants present in typical HVAC systems and are generally not capable of handling large air flows. Therefore, a basic need exists for an air filtration system that can not only remove dust and odor, but can also efficiently remove undesirable contaminants present in the air being moved through the air filtration system. The undesirable contaminants may include common irritants such as, but are not limited to, bacteria, germs, viruses, biological contaminants, volatile and non-volatile organic compounds, spores, pollen, mold and mold-byproducts (for example, mycotoxins), and the like.

### SUMMARY

In summary, the present invention may include a housing through which a pressurized air flow is driven. The housing defines a first chamber, a second chamber, and a third chamber. The second chamber is located downstream of the first chamber and the third chamber is located downstream of the second chamber. The pressurized air flow flows through a primary particulate filter that is positioned in the first chamber. The primary particulate filter is constructed and arranged for the removal of at least a portion of any particulate matter that is entrained in the air flow. For example, the primary particulate filter is capable of removing larger scale micron diameter particles and may be a conventional particulate filter or a conventional HEPA filter capable.

The ultraviolet lamp is positioned in the second chamber. The ultraviolet lamp emits radiation in a bandwidth suitable for the destruction of contaminants or irritants, such as biological, present or entrained in the air flow. In one example, the bandwidth may be in the range of about and between 245 to 265 nm. Also present in the second chamber is the permeable reaction filter. In operation, the pressurized air flow flows through the permeable reaction filter.

The permeable reaction filter and the ultraviolet light are constructed and arranged for the removal of at least a portion of the contaminants entrained in the air flow. The permeable reaction filter has a substrate member and a photo-catalytic oxidizer layer disposed thereon a portion of an upstream surface of the substrate member. In one example, the photo-catalytic oxidizer layer extends at least partially between the upstream surface and an opposed downstream surface of the substrate member. In use, the ultraviolet lamp irradiates at least a portion of the photo-catalytic oxidizer layer of the permeable reaction layer so that, as air is forced through the permeable reaction filter, some of the contaminants entrained in the air flow are caused to come into operational contact with activated portions of the photo-catalytic oxidation layer such that at least some of the contacted contaminants/pollutants in the air flow may be eliminated by photodegradation that is induced by the activated photo-catalyst.

To increase efficiency of the overall system, at least a portion of the second chamber of the air filtration system may include a reflective surface. In one example, at least a portion of the reflective surface faces a portion of a downstream side of the primary particulate filter. Further, a least a portion of the reflective surface may face a portion of the upstream surface of the permeable reaction filter.

### DETAILED DESCRIPTION OF THE FIGURES

These and other features and aspects of the present invention will become better understood with reference to the following description, appended claims, and accompanying drawings, where:

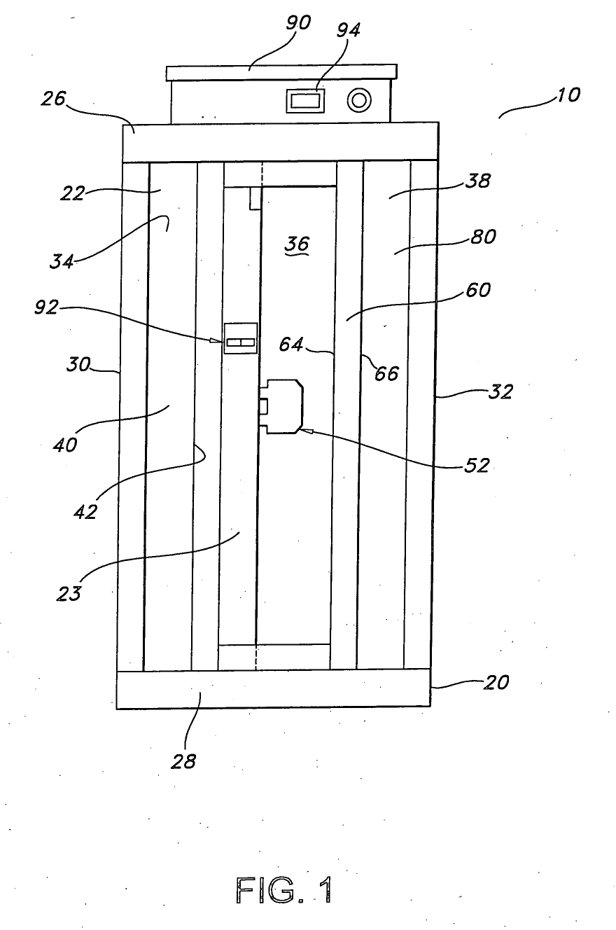

FIG. 1 is a schematic sectional side view of a first embodiment of the air filtration system of the present invention.

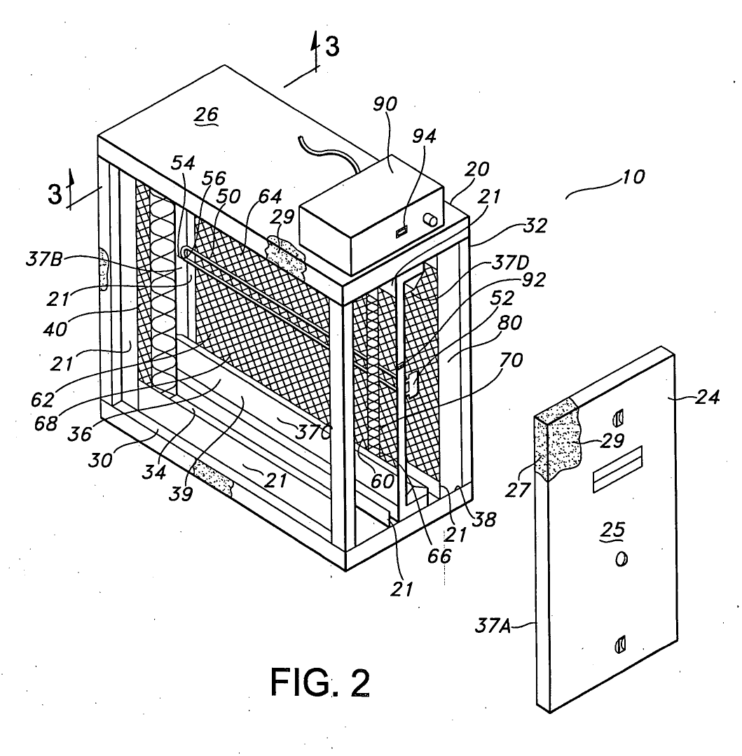

FIG. 2 is a partial exploded, partial sectional, perspective view of the first embodiment of an air filtration system of the present invention;

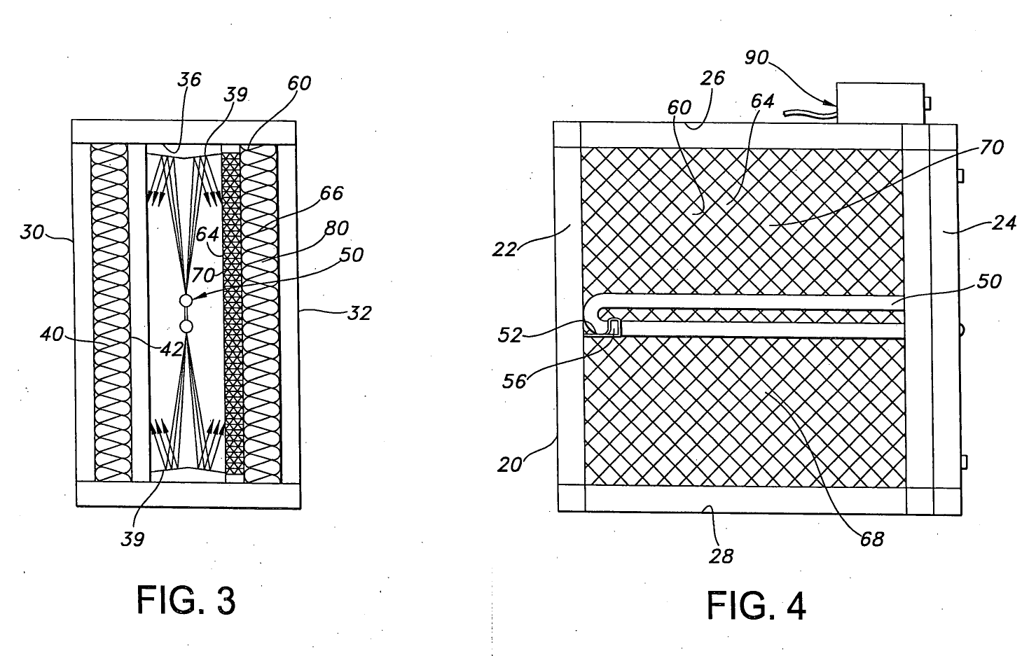

FIG. 3 is a cross-sectional view of the first embodiment of the air filtration system taken along line 3-3 of FIG. 1;

FIG. 4 is a side view of the first embodiment of the air filtration system with a primary particulate filter removed from the system and showing at least one ultraviolet lamp disposed in a second chamber and a portion of an upstream surface of a permeable reaction filter;

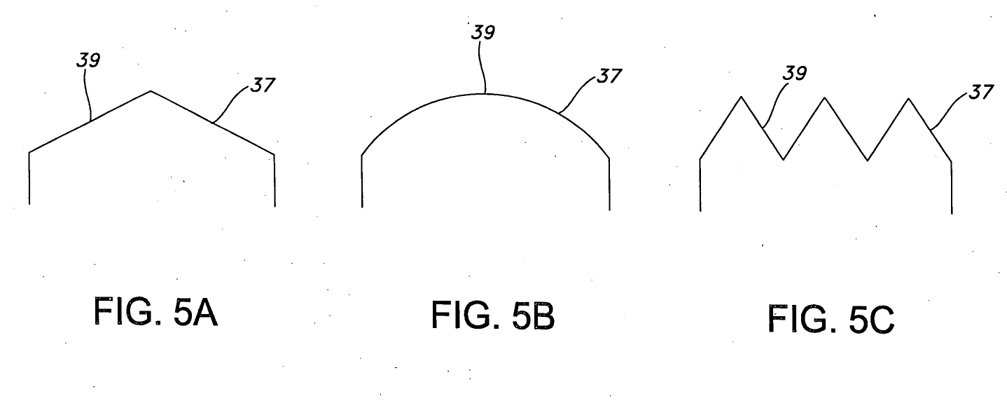

FIGS. 5A-5C are partial cross-sectional views of portions of a reflective surface of a second chamber of the air filtration system; and

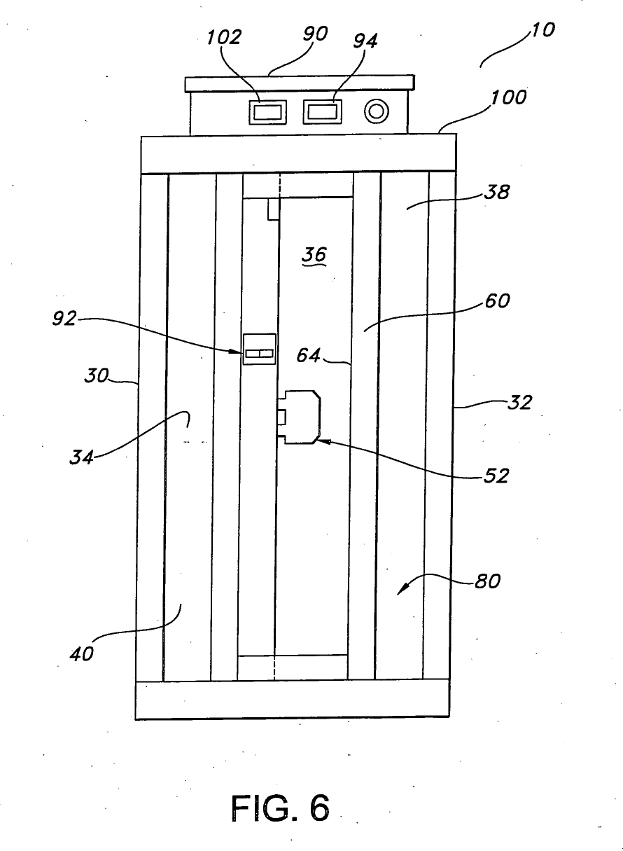

FIG. 6 is a schematic sectional side view of a second embodiment of the air filtration system of the present invention.

### DETAILED DESCRIPTION OF THE INVENTION

The present invention is more particularly described in the following exemplary embodiments that are intended as illustrative only since numerous modifications and variations therein will be apparent to those skilled in the art. As used herein, “a,” “an,” or “the” can mean one or more, depending upon the context in which it is used. The preferred embodiments are now described with reference to the figures, in which like reference characters indicate like parts throughout the several views.

As used herein, the term “contaminants” or “pollutants” may include common irritants such as, but are not limited to, bacteria, germs, viruses, biological contaminants, volatile and non-volatile organic compounds, spores, pollen, mold and mold byproducts (such as, for example, mycotoxins), and the like.

Referring to FIGS. 1-5, the air filtration system 10 of the present invention includes a housing 20 which comprises an inlet 30, an outlet 32, and three basic chambers 34, 36, 38 interconnected longitudinally one with the other between the inlet and outlet. A second chamber 36 is positioned adjacent to a first chamber 34, and a third chamber 38 is positioned adjacent to the second chamber. A pressurized air flow is caused to flow through the respective first, second, then third chambers of the housing by a conventional HVAC system air blower. As one will appreciate, the air flow may contain levels of contaminants that are entrained in the moving air flow as the air flow enters the housing.

In one embodiment, the housing 20 has a back wall panel 22, an opposed removable front wall panel 24, a top wall panel 26, and an opposed bottom wall panel 28. An edge portion of the back wall panel is connected to respective edge portions of the top wall panel and the bottom wall panel. Further, a mounting member 23 is constructed and arranged to extend between portion of the opposing edge portions of the top wall panel and the bottom wall panel. In use, the front wall panel is removably connected to portions of the mounting member so that, when removed, the operator may gain selective access to the chambers of the housing, and, when secured, the three chambers of the housing are substantially enclosed, between the inlet and the outlet of housing by portions of the front wall panel, the top wall panel, the bottom wall panel, and the back wall panel. In a further example, the respective wall panels may be formed from an outer lining 25 that is connected to an inner lining 27 and that sandwiches insulation 29, such as, for example, foam or fiberglass, therebetween.

The first chamber 34 contains a primary particulate filter 40. The primary particulate filter is conventional, such as, for example, a glass or fiber filter, and is effective in removing large micron diameter particulate matter as the air flow passes through the primary particulate filter. In one example, the primary particulate filter may be pleated. Further, the primary particulate filter may be a conventional HEPA filter that is generally suitable for the removal of particulate matter down to about 0.3 micron in diameter. In another example, the primary particulate filter may be treated with an oil-based solution and/or a visco-elastic solution (such as, for example, Mycelx™, and the like), which may attract droplets entrained within the air flow passing through the primary particulate filter.

The second chamber 36 is positioned downstream of the first chamber and contains at least one ultraviolet lamp 50 and a permeable reaction filter 60. In one embodiment, the permeable reaction filter is positioned downstream of the at least one ultraviolet lamp. Each ultraviolet lamp is a conventional germicidal lamp that emits radiation in a bandwidth suitable for the destruction of at least some of the entrained contaminants in the air flow as it passes through the second chamber. In the example shown, the at least one ultraviolet lamp is a conventional U-shaped germicidal ultraviolet lamp. Of course, other conventional ultraviolet lamps may be used as desired. Preferably, the at least one ultraviolet lamp emits radiation in a bandwidth in the range of about 230 to 300 nm; more preferably, in the range of about 245 to 265 nm; still more preferably, in the range of about 250-260 nm. In another example, the at least one ultraviolet lamp emits radiation at a wavelength of about 254 nm.

The second chamber 36 has at least one side wall 37 and the at least one ultraviolet lamp 50 may be positioned onto a suitable, conventional, light fixture 52 that is mounted to or adjacent the side wall. In one example, the light fixture is connected to a portion of the mounting member 23 so that the lamp may be readily replaced when the front wall panel of the housing is removed. In another example, to help support the lamp while is use, a pin 54 may extend from the back wall panel into the interior of the second chamber that is releasably connected to a clip 56 mounted onto a portion of the lamp. In this example, as one would appreciate, the lamp would be supported at both ends. In the example shown, the at least one ultraviolet lamp extends from the sidewall of the second chamber into the interior of the second chamber so that the ultraviolet lamp is positioned substantially transverse to direction of the air flow passing through the second chamber. In this position, the ultraviolet lamp is generally parallel to an upstream surface of the permeable reaction filter and a downstream side of the primary reaction filter.

The permeable reaction filter 60 and the at least one ultraviolet lamp 50 are constructed and arranged for the removal of at least a portion of contaminants entrained in the air flow that passes through the second chamber. The permeable reaction filter has a substrate member 62 that has an upstream surface 64 and an opposed downstream surface 66. The permeable reaction filter also has a photo-catalytic oxidizer layer 70 disposed thereon a portion of the substrate member, more particularly, being positioned on portions of the upstream surface of the substrate member. In one example, the photo-catalytic oxidizer layer extends at least partially between the upstream surface and the downstream surface of the substrate member. In another example, the photo-catalytic oxidizer layer extends substantially between the upstream surface to the downstream surface of the permeable reaction filter. The reaction filter 60 is positioned downstream of the particulate filter so that the photo-catalytic oxidizer layer is not degraded or deactivated due to contamination that may be caused by deposits of inorganic contamination, such as, for example, dust and soil. In the present invention, any contamination is minimized due to the filtering of the air flow by the primary particulate filter 40 prior to the air flows introduction into the second chamber.

In one example, the substrate of the permeable reaction filter is formed from a plurality of fibers 68 that are formed into a desired shape. The desired shape may include a conventional pleated shape, a planar shape, and the like. Other conventional shapes for the substrate of the permeable reaction filter are contemplated. The fibers of the substrate may be selected from the group comprising, for example, polymer fibers, glass quartz fibers, natural fibers, the like, and combinations thereof.

In one example, the photo-catalytic oxidizer layer is formed from a plurality of titanium dioxide particles, which act as the photo-catalyst, that are disposed onto portions of the substrate. Each of the titanium dioxide particles may be bonded to at least one fiber of the plurality of fibers. In one example, the titanium dioxide particles may be imposed on the substrate by dipping at least a portion of the substrate into a titanium dioxide water suspension and then calcinating at an elevated temperature for a period of time. As one will appreciate, other conventional means of imposing the titanium dioxide particles on the substrate are contemplated.

In use, the at least one ultraviolet lamp irradiates at least a portion of the photo-catalytic oxidizer layer of the permeable reaction filter to activate portions of the photo-catalytic oxidizer layer. In gas-phase applications, when a target gas in the air flow is adsorbed into/onto the photo-catalyst and the catalyst is activated (or illuminated), electron-hole pairs are generated at the sub-atomic level within the catalyst. Generally, the electrons reduce oxygen and the holes are available to oxidize organic and inorganic compounds. Thus, when illuminated by radiation emitted by the at least one ultraviolet light, titanium dioxide (TiO₂), which is the photo-catalyst in this example and which is a semiconductor photo-catalyst with a band gap energy of generally 3.2 eV, generates positive holes (h⁺) and electrons (e⁻). When this exemplary photo-catalyst is irradiated with photons of less than 385 nm, the band gap energy is exceeded and an electron is promoted from the valence band to the conduction band. The resultant electron-hole pair has a lifetime in the space-charge region that enables its participation in chemical reactions. The most widely postulated reactions are shown here.

OH—+h+→.OH

O₂+e−→O₂—

Hydroxyl radicals and super-oxide ions are highly reactive species that will oxidize volatile organic compounds (VOCs) adsorbed on the catalyst surface. They may also eliminate and/or decompose adsorbed bioaerosols. The process is referred to as heterogeneous photocatalysis or, more specifically, photocatalytic oxidation (PCO). In use, contaminants and pollutants, particularly VOCs, are preferentially adsorbed on the surface of the individual particles of the photo-catalyst and oxidize to (primarily) carbon dioxide (CO₂). Thus, rather than simply changing the phase and concentrating the contaminant, the absolute toxicity of the treated air stream is reduced, allowing the photo-catalytic reactor to operate as a self-cleaning filter relative to organic material on the catalyst surface. Such a photo-catalytic reactor, as integrated in the air filtration system of the present invention, has low power consumption, a potentially long service life, and low maintenance requirements. These attributes contribute to the effectiveness of the present invention, when compared to prior art devices, for removing and destroying low level pollutants in indoor air, including bacteria, viruses, fungi, mold, mycotoxins, and the like.

In the present invention, when activated, contaminants/pollutants entrained in the air flow may be destroyed by photodegradation as the air flow is forced through the permeable reaction filter because at least some of the entrained contaminants are caused to come into operational contact with activated portions of the photo-catalytic oxidizer layer. Preferably, at least about 50% of the contaminants/pollutants still present in the air flow passing through the permeable reaction filter come into operational contact with the positive holes (h⁺) and electrons (e⁻) generated by the activated portions of the photo-catalytic oxidizer layer. More preferred, the operational contact of the remaining contaminants/pollutants is in the range of about 60-80%; still more preferred, in the range of about 70-90%; and, in another example, in the range of about 80-95%. Unlike the prior art devices, which rather inefficiently destroyed contaminants/pollutants in the air flow, the present design, with the combined effects of the at least one ultraviolet lamp 50 and the actuation of the photo-catalytic oxidizer layer 70 of the permeable reaction filter 60, markedly increases the efficiency of the air filtration system.

The permeable reaction filter 60 has a MERV rating suitable for the use in which the air filtration system of the present invention is implemented. Thus, for example, for conventional residential or commercial structures, the permeable reaction filter has a MERV rating in the range of about and between 1-12 MERV, which is suitable for air flows that are suitable for typical residential or commercial structures. In an alternative example, such as a manufacturing clean room, the permeable reaction filter a MERV rating in the range of about and between 12-20 MERV, which is suitable for the generally higher pressurized air flows used for such applications.

An adsorption filter 80 may be positioned in the third chamber 38 downstream of the permeable reaction filter 60. The adsorption filter may be, for example, a conventional activated carbon filter that is suitable for adsorption of odors present in the air flow, of byproducts produced by the photodegradation process that occurs in the second chamber, and of at least some of the remaining contaminants entrained in the air flow. The adsorption filter is positioned downstream of the reaction filter so that products produced by incomplete oxidation as the air passes through the activated photo-catalytic oxidizer layer of the permeable reaction filter may be captured by the adsorption filter.

For increased efficiency, at least a portion of the second chamber 36 defines a reflective surface 39. As noted above, the second chamber has at least one side wall 37, for example: a front side wall 37A, a back side wall 37B, a bottom side wall 37C, and a top side wall 37D. At least a portion of one of the walls forming the second chamber 36 forms the reflective surface so that radiation emitted from the at least one ultraviolet lamp 50 may be reflected as desired. In one example, to enhance the reflective quality of the reflective surface, the portion of one of the walls of the second chamber is formed from aluminum, preferably brushed aluminum. Further, a layer of chromium may be disposed on at least a portion of the reflective surface. As one will appreciate, substantially all or just a portion of the walls forming the second chamber may be formed from the desired material and form the reflective surface. Referring to FIGS. 3 and 5A-5C, at least a portion of the reflective surface faces a portion of the upstream surface 64 of the permeable reaction filter 60. Thus, in operation, radiation from the at least one ultraviolet lamp may be directly radiated into at least a portion of the upstream surface of the permeable reaction filter and may be indirectly radiated, via reflection from the reflective surface, into at least a portion of the upstream surface of the permeable reaction filter. This allows for more efficient activation of the photo-catalyst present in the photo-catalytic oxidation layer of the permeable reaction filter.

In addition, a portion of the reflective surface 39 may face a portion of the downstream side 42 of the primary particulate filter 40. Thus, in like operation, radiation from the at least one ultraviolet lamp may be directly radiated into at least a portion of the downstream side of the primary particulate filter and may be indirectly radiated, via reflection from the reflective surface, into at least a portion of the downstream side of the primary particulate filter. The direct and indirect radiation impacting and penetrating the fibers that form the primary particulate filter serves to heat the fibers to a higher degree than prior art designs. The increased heating makes the fibers more “sticky” and results in an increased efficiency of the primary particulate filter in arresting particulate matter. As one will appreciate, the fibers of the primary particulate filter may be, for example, conventional synthetic or natural fibers, and the like. Radiation penetrating the primary particulate filter serves to help destroy at least some of the contaminants that have become trapped within the filter. Thus, as least some of the contaminants are destroyed that, in conventional systems, may have formed germ colonies that could be sloughed off into passing air and thence into the ventilation system.

FIGS. 5A-5C illustrate some exemplary cross-sectional shapes of the reflective surface. The cross-sectional shape may comprise, but are not limited to, a convex shape, a triangular shape, a saw-tooth shape, and the like. One skilled in the art would appreciate that other reflective surface shapes are contemplated.

As noted above, the housing 20 may include a removable front wall panel 24 so that the interior of the housing may be readily accessed. Within the chambers of the housing, a plurality of elongated rails 21 may be positioned on portions of the interior surface of the housing to form brackets that are constructed and arranged for securing the primary particulate filter, the permeable reaction filter, and, if used, the adsorption filter. Preferably, the filters are mounted so that they are transverse to the direction of the air flow in the housing.

The air filtration system includes a conventional power source 90 electrically connected to the at least one ultraviolet lamp 50. As one will appreciate, the power source may be electrically coupled to an external source of electrical power (not shown), such as an electrical outlet or the electrical distribution system of the structure in which the system is placed in operation. The system may also include a pressure sensitive actuation switch 92 that is electrically coupled, for example, in series, to the power source 90 and the at least one ultraviolet lamp 50. The actuation switch is constructed and arranged so that the actuation switch is released to an off position, in which power is not transmitted to the ultraviolet lamp, when the front wall panel 24 is removed. The actuation switch is pushed to an on position, in which power is transmitted to the ultraviolet lamp, when the front wall panel is releasably connected such that interior of the housing, and the ultraviolet lamp 50 disposed in the second chamber 36 thereof, are substantially enclosed between the inlet and outlet of the housing. A manually selectable on/off electrical switch 94 may also be electrically coupled, for example, in series, with the actuation switch so that an operator can selectively control the flow of power to the ultraviolet lamp and the actuation switch.

Referring now to FIG. 6, a second embodiment of the present invention is shown which relates to a portable air filtration system for removing contaminants present in the ambient atmosphere. In this embodiment, a blower 100 having a fan is incorporated into and is in fluid communication with the interior of the housing so that air may be drawn into the inlet 30 of the housing 20, passed through the first, second, and third chambers and exhausted out of the outlet 32. The blower is constructed and arranged for generating an air stream, i.e. an air flow that is discharged from the outlet of the housing into the ambient atmosphere. In one example, the blower is positioned upstream of the primary particulate filter 40 proximate the inlet of the housing. In another example, and as shown, the blower may be positioned downstream of the permeable reaction filter 60, or, if used, downstream of the adsorption filter 80. As one will appreciate, the blower may be positioned at any point intermediate the inlet and outlet of the housing. The blower is electrically coupled to the power source. A separate manually selectable on/off electrical switch 102 may be provided that may be electrically coupled, for example, in series, with the actuation switch so that an operator can selectively control the flow of power to the blower.

Although the illustrative embodiments of the present disclosure have been described herein with reference to the accompanying drawings, it is to be understood that the disclosure is not limited to those precise embodiment, and that various other changes and modifications may be affected therein by one skilled in the art without departing from the scope of spirit of the disclosure. All such changes and modifications are intended to be included within the scope of the disclosure as defined by the appended claims.

What is claimed is:

1. An air filtration system for use in filtering a pressurized air flow, the system comprising:
a housing through which the air flow is caused to pass, the housing defining a first chamber, a second chamber downstream of the first chamber, and a third chamber downstream of the second chamber;
a primary particulate filter positioned in the first chamber constructed and arranged for the removal of at least a portion of particulate matter entrained in the air flow;
at least one ultraviolet lamp positioned in the second chamber;
a permeable reaction filter positioned in the second chamber downstream of the at least one ultraviolet light, the permeable reaction filter and the at least one ultraviolet light constructed and arranged for the removal of at least a portion of contaminants entrained in the air flow, the permeable reaction filter having a substrate member and a photo-catalytic oxidizer layer disposed thereon a portion of the substrate member, said substrate member having an upstream surface and an opposed downstream surface, said photo-catalytic oxidizer layer being positioned on portions of the upstream surface and extending at least partially between the upstream surface and the downstream surface of the substrate member, said at least one ultraviolet lamp being constructed and arranged to irradiate at least a portion of the photo-catalytic oxidizer layer of the permeable reaction filter; and
an adsorption filter positioned in the third chamber.

2. The air filtration system of claim 1, wherein at least a portion of the second chamber defines a reflective surface.

3. The air filtration system of claim 2, wherein the reflective surface is formed from aluminum.

4. The air filtration system of claim 3, wherein the reflective surface is formed from brushed aluminum.

5. The air filtration system of claim 4, further comprising a layer of chromium disposed on at least a portion of the reflective surface.

6. The air filtration system of claim 2, wherein at least a portion of the reflective surface faces a portion of a downstream side of the primary particulate filter.

7. The air filtration system of claim 6, wherein at least a portion of the reflective surface faces a portion of the upstream surface of the permeable reaction filter.

8. The air filtration system of claim 1, wherein the at least one ultraviolet lamp irradiates at least a portion of a downstream side of the primary particulate filter.

9. The air filtration system of claim 8, wherein the primary particulate filter is pleated.

10. The air filtration system of claim 1, wherein the at least one ultraviolet lamp emits in a bandwidth in the range of about 245 to 265 nm.

11. The air filtration system of claim 10, wherein the at least one ultraviolet lamp is emitted at a wavelength of about 254 nm.

12. The air filtration system of claim 1, wherein each ultraviolet lamp is substantially U-shaped.

13. The air filtration system of claim 1, wherein the photo-catalytic oxidizer layer is formed of a plurality of titanium dioxide particles bonded to portions of the substrate.

14. The air filtration system of claim 1, wherein the substrate of the permeable reaction filter has a plurality of fibers and wherein each titanium dioxide particle is bonded to at least one fiber of said plurality of fibers.

15. The air filtration system of claim 14, wherein the fibers of the substrate are selected from a group consisting of polymer fibers, glass quartz fibers, natural fibers or a combination thereof.

16. The air filtration system of claim 14, wherein the substrate of the permeable reaction filter is pleated.

17. The air filtration system of claim 1, wherein the photo-catalytic oxidizer layer extends substantially between the upstream surface to the downstream surface of the permeable reaction filter.

18. The air filtration system of claim 1, wherein the permeable reaction filter has a MERV rating in the range of about and between 1-12 MERV.

19. The air filtration system of claim 1, wherein the adsorption filter comprises an activated carbon filter.

20. The air filtration system of claim 1, wherein the second chamber is adjacent to the first chamber, and wherein the third chamber is adjacent to the second chamber.

21. The air filtration system of claim 1, further comprising a blower constructed and arranged to supply the pressurized air flow, the blower in fluid communication with the housing.

22. The air filtration system of claim 21, wherein the blower is positioned upstream of the primary particulate filter.

23. The air filtration system of claim 21, wherein the blower is positioned downstream of the adsorption filter.

24. An air filtration system for use in filtering a pressurized air flow, the system comprising:
a primary particulate filter means for the removal of at least a portion of particulate matter entrained in the air flow;
at least one ultraviolet lamp positioned downstream of the primary particulate filter means; and
a permeable reaction filter positioned downstream of the at least one ultraviolet light, the permeable reaction filter and the at least one ultraviolet light constructed and arranged for the removal of at least a portion of contaminants entrained in the air flow, the permeable reaction filter having a substrate member and a photo-catalytic oxidizer layer disposed thereon a portion of the substrate member, said substrate member having an upstream surface and an opposed downstream surface, said photo-catalytic oxidizer layer being positioned on portions of the upstream surface and extending at least partially between the upstream surface and the downstream surface of the substrate member, said at least one ultraviolet lamp being constructed and arranged to irradiate at least a portion of the permeable reaction layer.

25. The air filtration system of claim 24, further comprising an adsorption filter means positioned downstream of the permeable reaction filter.

26. The air filtration system of claim 24, further comprising a reflective surface positioned intermediate the primary particulate filter means and the permeable reaction filter, the reflective surface constructed and arranged to reflect irradiation from the at least one ultraviolet lamp.

27. The air filtration system of claim 26, wherein the reflective surface is formed from aluminum.

28. The air filtration system of claim 27, wherein the reflective surface is formed from brushed aluminum.

29. The air filtration system of claim 28, further comprising a layer of chromium disposed on at least a portion of the reflective surface.

30. The air filtration system of claim 26, wherein at least a portion of the reflective surface faces a portion of the upstream surface of the permeable reaction filter.

31. The air filtration system of claim 30, wherein at least a portion of the reflective surface faces a portion of a downstream side of the primary particulate filter means.

32. The air filtration system of claim 24, wherein the at least one ultraviolet lamp irradiates at least a portion of a downstream side of the primary particulate filter.

33. The air filtration system of claim 24, wherein the at least one ultraviolet lamp emits in a bandwidth in the range of about 245 to 265 nm.

34. The air filtration system of claim 33, wherein the at least one ultraviolet lamp is emitted at a wavelength of about 254 nm.

35. The air filtration system of claim 24, wherein the photo-catalytic oxidizer layer is formed of a plurality of titanium dioxide particles bonded to portions of the substrate.

36. The air filtration system of claim 24, wherein the substrate of the permeable reaction filter has a plurality of fibers and wherein each titanium dioxide particle is bonded to at least one fiber of said plurality of fibers.

37. The air filtration system of claim 24, wherein the photo-catalytic oxidizer layer extends substantially between the upstream surface to the downstream surface of the permeable reaction filter.

38. The air filtration system of claim 24, wherein the adsorption filter means comprises an activated carbon filter.

39. An air filtration system for use in filtering a pressurized air flow, the system comprising:
a primary particulate filter for the removal of at least a portion of particulate matter entrained in the air flow;
at least one ultraviolet lamp positioned downstream of the primary particulate filter; and
a permeable reaction filter positioned downstream of the at least one ultraviolet light, the permeable reaction filter and the at least one ultraviolet light constructed and arranged for the removal of at least a portion of contaminants entrained in the air flow, the permeable reaction filter having a substrate member and a plurality of titanium dioxide particles bonded to portions of said substrate to form a photo-catalytic oxidizer layer disposed thereon a portion of the substrate member, said substrate member having an upstream surface and an opposed downstream surface, said photo-catalytic oxidizer layer being positioned on portions of the upstream surface and extending at least partially between the upstream surface and the downstream surface of the substrate member, said at least one ultraviolet lamp being constructed and arranged to irradiate at least a portion of the permeable reaction layer.

40. The air filtration system of claim 39, further comprising an adsorption filter positioned downstream of the permeable reaction filter.

41. The air filtration system of claim 39, further comprising a reflective surface positioned intermediate the primary particulate filter means and the permeable reaction filter, the reflective surface constructed and arranged to reflect irradiation from the at least one ultraviolet lamp.

42. The air filtration system of claim 39, wherein the substrate of the permeable reaction filter has a plurality of fibers and wherein each titanium dioxide particle is bonded to at least one fiber of said plurality of fibers.

43. The air filtration system of claim 39, wherein the photo-catalytic oxidizer layer extends substantially between the upstream surface to the downstream surface of the permeable reaction filter.
